(19) United States
(12) Patent Application Publication
(10) Pub. No.: US 2026/0269514 A1
(43) Pub. Date: Sep. 10, 2026

(54) PROTECTIVE SLEEVE FOR COAXIAL CABLE AND ELECTRONIC DEVICE USING THE SAME

(71) Applicant: Arcadyan Technology Corporation, Hsinchu City (TW)

(72) Inventors: Sheng-Chung CHEN, Hsinchu County (TW); Shih-Hsin HUANG, Hsinchu County (TW)

(21) Appl. No.: 19/453,327

(22) Filed: Jan. 20, 2026

(30) Foreign Application Priority Data
Mar. 4, 2025 (TW) 114107885

(51) Int. Cl. H01R 13/516; H01R 24/40; H01R 103/00

(52) U.S. Cl. CPC H01R 13/516; H01R 24/40; H01R 2103/00

(57) ABSTRACT

A protective sleeve includes a sleeve body and a first protruding portion. The sleeve body has a central axis and an inner peripheral surface surrounding the central axis. The first protruding portion is connected to the inner peripheral surface and protrudes relative to the inner peripheral surface.

### RELATED APPLCATION

This application claims the benefit of Taiwan application Serial No. 114107885, filed March 4, 2025, the subject matter of which is incorporated herein by reference.

### BACKGROUND OF THE INVENTION

### Field of Invention

The invention relates in general to a protective sleeve for a coaxial cable and an electronic device using the same.

### Description of the Related Art

Currently, in the process of attaching a coaxial cable to a coaxial cable connector, a wrench is needed to turn a nut of the coaxial cable to lock it into the coaxial cable connector. However, sometimes the wrench's movement is hindered due to a limited operating space. Therefore, how to improve the aforementioned conventional problem is one of the goals of those in the art.

### SUMMARY OF THE INVENTION

According to an embodiment of the present invention, a protective sleeve for a coaxial cable is provided. The protective sleeve includes a sleeve body and a first protrusion. The sleeve body has a central axis and an inner peripheral surface surrounding the central axis. The first protrusion is connected to the inner peripheral surface and protrudes relative to the inner peripheral surface.

According to another embodiment of the present invention, an electronic device is provided. The electronic device includes a housing, a fixing element, a coaxial cable connector and a protective sleeve. The housing has a lateral surface. The fixing element is connected to the housing. The coaxial cable connector is disposed within the housing and protrudes relative to the lateral surface. The protective sleeve includes a sleeve body and a first protrusion. The sleeve body has a central axis and an inner peripheral surface surrounding the central axis. The first protrusion is connected to the inner peripheral surface and protrudes relative to the inner peripheral surface.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1A illustrates a schematic diagram of an electronic device according to an embodiment of the present invention;

FIG. 1B illustrates a schematic diagram of the wiring structure of the electronic device according to an embodiment of the present invention from different perspective;

FIG. 2A illustrates an exploded view of the wiring structure in FIG. 1A;

FIG. 2B illustrates an exploded view of the wiring structure in FIG. 1B;

FIG. 2C illustrates a cross-sectional view of a housing and a fixing element of the electronic device in FIG. 2A along a direction 2C to 2C';

FIG. 3A illustrates a front view of the wiring structure in FIG. 1A along the –Z-axis;

FIG. 3B illustrates a cross-sectional view of the wiring structure in FIG. 3A along a direction 3B-3B';

FIG. 4A illustrates a front view of the protective sleeve in FIG. 2B along in the -Z-axis;

FIG. 4B illustrates a front view of the protective sleeve in FIG. 2B along the +Z-axis; and

FIG. 5 illustrates a schematic diagram of a housing and a fixing element according to another embodiment of the present invention.

### DETAILED DESCRIPTION OF THE INVENTION

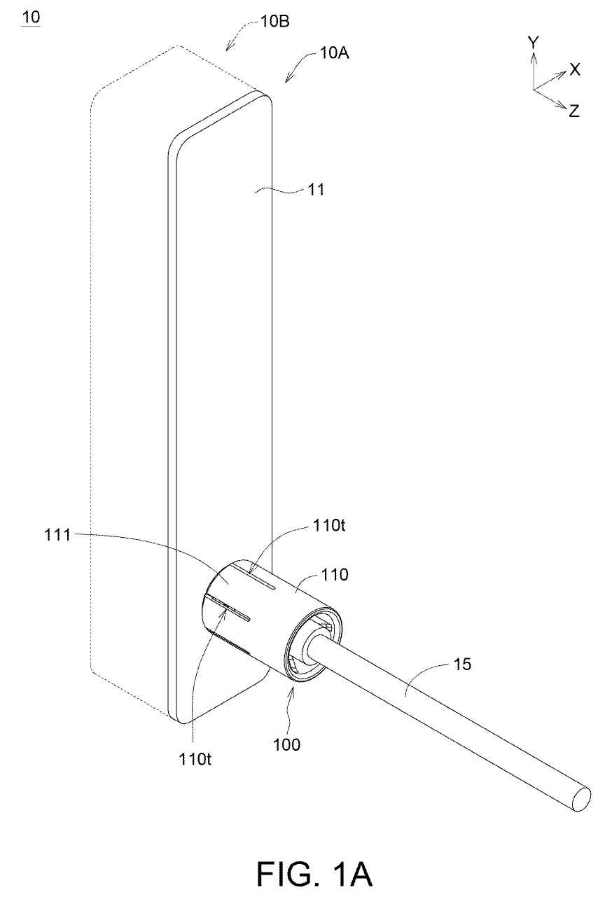

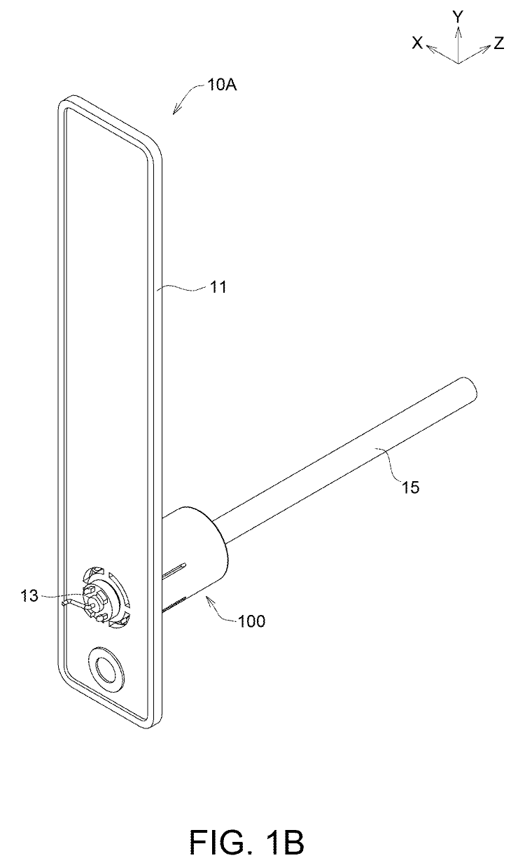

Referring to FIGS. 1A to 4B, FIG. 1A illustrates a schematic diagram of an electronic device 10 according to an embodiment of the present invention, wherein the solid lines represent a wiring structure 10A of the electronic device 10. In an embodiment, the electronic device 10 is, for example, a network communication device. Although not illustrated, the electronic device 10 further includes electronic components related to network communication, such as a circuit board, a communication chip disposed on the circuit board, etc.

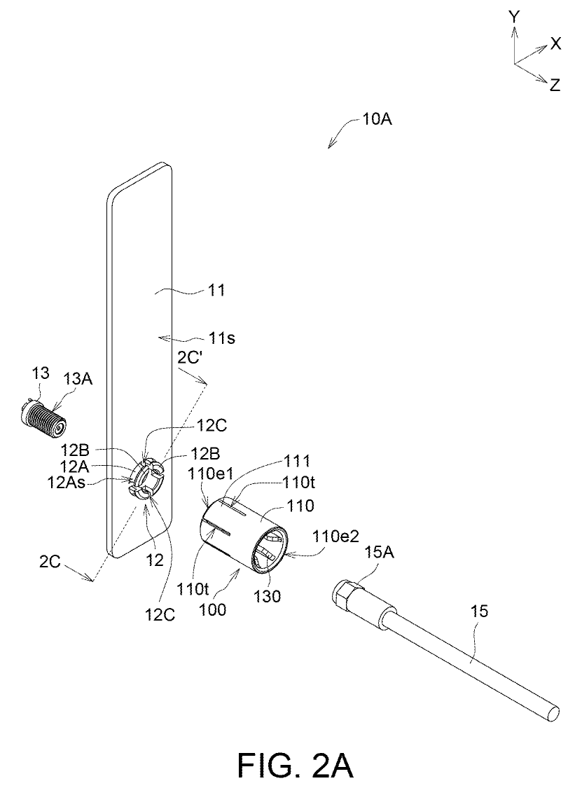

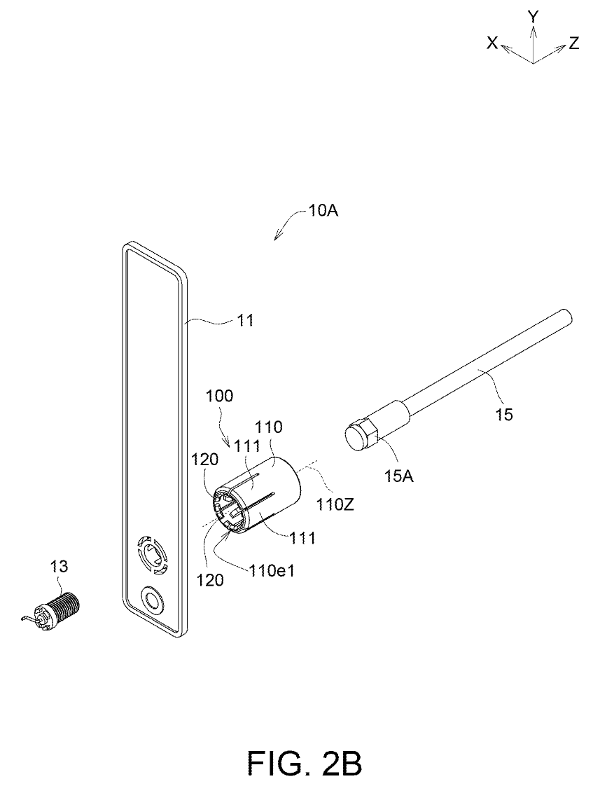

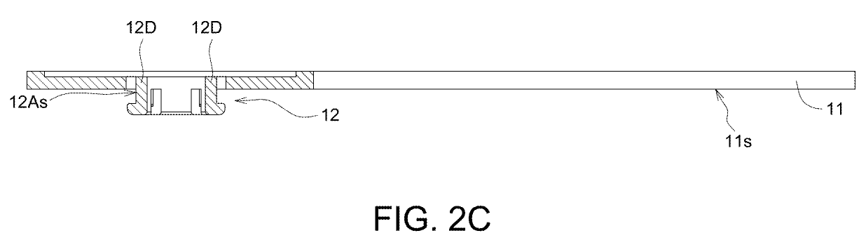

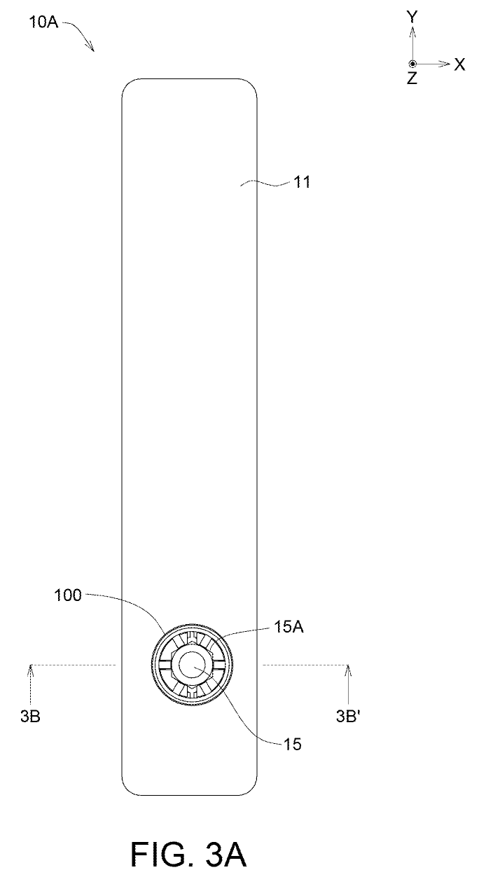

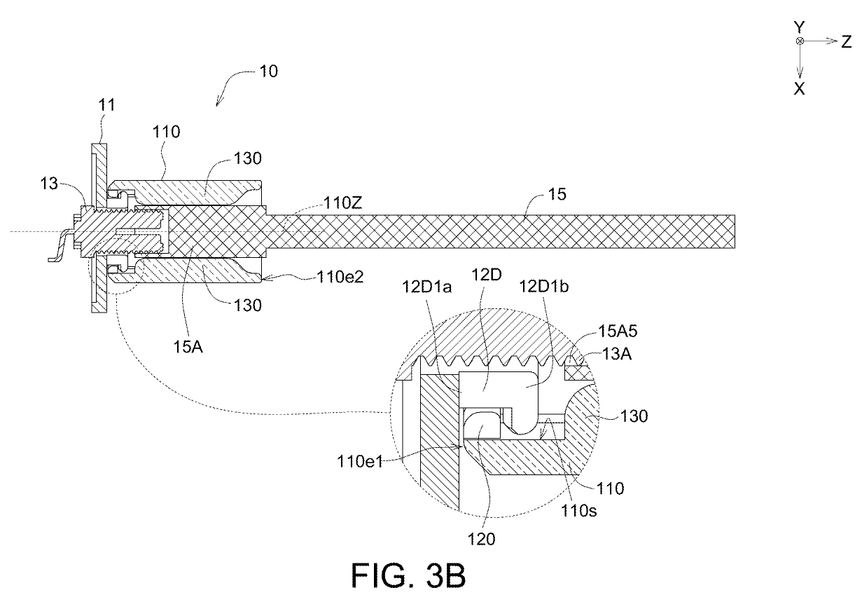

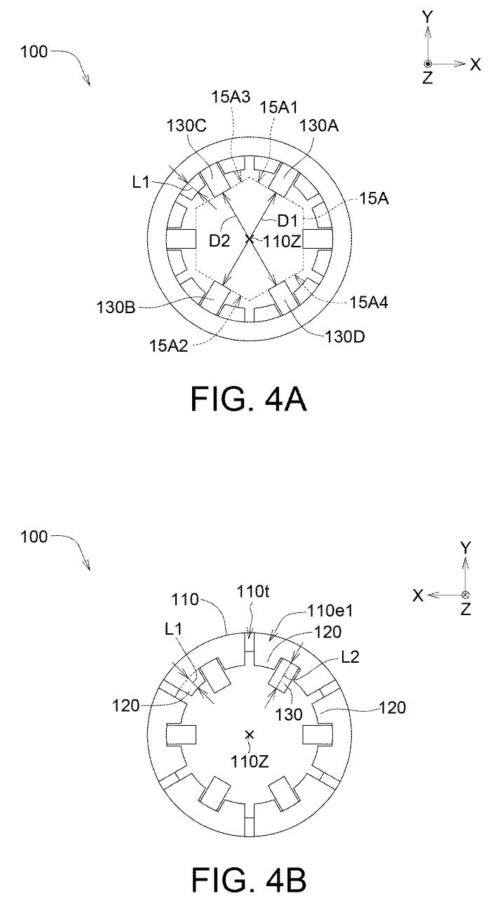

FIG. 1B illustrates a schematic diagram of the wiring structure 10A of the electronic device 10 according to an embodiment of the present invention from different perspective, FIG. 2A illustrates an exploded view of the wiring structure 10A in FIG. 1A, FIG. 2B illustrates an exploded view of the wiring structure 10A in FIG. 1B, FIG. 2C illustrates a cross-sectional view of a housing 11 and a fixing element 12 of the electronic device in FIG. 2A along a direction 2C to 2C', FIG. 3A illustrates a front view of the wiring structure 10A in FIG. 1A along the –Z-axis, FIG. 3B illustrates a cross-sectional view of the wiring structure 10A in FIG. 3A along a direction 3B-3B', FIG. 4A illustrates a front view of the protective sleeve 100 in FIG. 2B along in the -Z-axis, and FIG. 4B illustrates a front view of the protective sleeve 100 in FIG. 2B along the +Z-axis.

As illustrated in FIGS. 1A to 2B, the electronic device 10 includes the wiring structure 10A and a shell 10B. The wiring structure 10A includes the housing 11, the fixing element 12, a coaxial cable connector 13 and a protective sleeve 100. The housing 11 has a lateral surface 11s. The fixing element 12 is connected to the housing 11. The coaxial cable connector 13 is disposed within the housing 11 and protrudes relative to the lateral surface 11s. The protective sleeve 100 is fixed to the fixing element 12 and covers a portion of the coaxial cable 15 (e.g., a connector 15A) for protecting that portion of the coaxial cable 15. Due to the connector 15A being covered by the protective sleeve 100, it may prevent the human body from contacting with the connector 15A (if the connector 15A has high temperature or leakage current, it may prevent injury caused by contact).

As illustrated in FIG. 1A, in an embodiment, the housing 11 is, for example, a lateral plate of the electronic device 10 which may be assembled to the shell 10B of the electronic device 10. Alternatively, the housing 11 is, for example, a part of the shell 10B of the electronic device 10. As illustrated in FIG. 2A, the housing 11 and the fixing element 12 are formed, for example, into an integral structure. In terms of manufacturing method, the housing 11 and the fixing element 12 may be formed, for example, by injection molding. Alternatively, the housing 11 and the fixing element 12 are manufactured independently and then joined together by means of adhesive, snap-fit, screwing, welding, etc. In terms of material, the housing 11 and/or the fixing element 12 are, for example, made of plastic or metal.

As illustrated in FIGS. 2B and 3B, the protective sleeve 100 includes a sleeve body 110, at least one first protrusion 120, and at least one second protrusion 130. The sleeve body 110 has a central axis 110Z and an inner peripheral surface 110s, wherein the inner peripheral surface 110s surrounds the central axis 110Z. The first protrusion 120 is connected to and protrudes relative to the inner peripheral surface 110s. As a result, the first protrusion 120 may be engaged with the fixing element 12, and it may prevent the protective sleeve 100 and the fixing element 12 from being easily separated.

As illustrated in FIGS. 2B and 4B, a plurality of first protrusions 120 surrounds the central axis 110Z of the sleeve body 110 (e.g., parallel to the Z-axis). The sleeve body 110 has a first end surface 110e1 and a second end surface 110e2 opposite to the first end surface 110e1. In an embodiment, the first protrusion 120 is connected to the first end surface 110e1, making it easier for the first protrusion 120 to be engaged with the fixing element 12. In other words, the first protrusion 120 may extend to the first end surface 110e1. Furthermore, the number of first protrusions 120 may be one or more. The number of the first protrusions 120 is not limited in this embodiment of the invention.

As illustrated in FIGS. 2A, 2C, and 3B, the fixing element 12 includes a fastening body 12A and a flange 12B, wherein the fastening body 12A has an outer peripheral surface 12As. The flange 12B is connected to the fastening body 12A and protrudes relative to the outer peripheral surface 12As. In an embodiment, the first protrusion 120 of the protective sleeve 100 overlaps with the flange 12B along an extension direction of the central axis 110Z of the sleeve body 110. As a result, the protective sleeve 100 and the fixing element 12 will not detach along the extension direction of the central axis 110Z. Furthermore, when the coaxial cable 15 and the fixing element 12 are subjected to an external force along the Z-axis, the first protrusion 120 and the flange 12B overlap along the extension direction of the central axis 110Z of the sleeve body 110, and it cause them to abut against each other and thus prevent the coaxial cable 15 from easily separating from the fixing element 12. Furthermore, the first protrusion 120 and the flange 12B are not fixed and may therefore rotate relative to each other.

As illustrated in FIGS. 2A, 3B, and 4A, the second protrusions 130 are connected to the inner peripheral surface 110s of the sleeve body 110, protrude relative to the inner peripheral surface 110s and surround the central axis 110Z of the sleeve body 110. The extension direction of each second protrusion 130 is substantially parallel to the central axis 110Z. In an embodiment, the second protrusion 130 is spaced apart from the first protrusion 120, for example, the second protrusion 130 and the first protrusion 120 are spaced apart about the central axis 110Z.

As illustrated in FIGS. 2A and 4A, the second protrusions 130 may drive the connector 15A of the coaxial cable 15 to rotate. Furthermore, a distance between any two opposite second protrusions 130 is substantially equal to a distance between any other opposite second protrusions 130, and a line connecting the opposite protrusions passes through the central axis 110Z. Thus, the second protrusions 130 may be adapted to restrict a rotational freedom of the connector 15A of the coaxial cable 15, wherein the connector 15A is, for example, a polygonal element, such as a polygonal nut. The number of the second protrusions 130 may depend on the number of the lateral surfaces of the polygonal element. For example, if the polygonal element is hexagonal (e.g., connector 15A is a hexagonal nut), then the number of the second protrusions 130 is six.

As illustrated in FIGS. 2A and 4A, the second protrusions 130 include at least second protrusions 130A, 130B, 130C and 130D. A distance D1 between second protrusions 130A and 130B is substantially equal to a distance D2 between second protrusions 130C and 130D, a line connecting the second protrusion 130A with the second protrusion 130B passes through the central axis 110Z, and a line connecting the second protrusion 130C with the second protrusion 130D passes through the central axis 110Z. As a result, the second protrusion 130A and the second protrusion 130B may respectively abut or approach the opposite two lateral surfaces 15A1 and 15A2 of the connector 15A, and the second protrusion 130C and the second protrusion 130D may respectively abut or approach the opposite two lateral surfaces 15A3 and 15A4 of the connector 15A. As a result, when the protective sleeve 100 rotates (e.g., about the Z-axis), these second protrusions 130 abut against multiple lateral surfaces of the connector 15A to drive the connector 15A to rotate. By the protective sleeve 100, the connector 15A may be rotated without additional tools (e.g., a hex wrench). Furthermore, an outer surface of the sleeve body 110 may have a non-slip structure (e.g., a roughened structure) to prevent fingers from sliding relative to the sleeve body 110 when rotating sleeve body 110.

As illustrated in FIG. 3B, the connector 15A has an internal thread 15A5, while the coaxial cable connector 13 has an external thread 13A. The internal thread 15A5 and the external thread 13A are screwed together. When the connector 15A rotates about the Z-axis, the connector 15A may move along the +Z-axis or -Z-axis through a helical movement of the internal thread 15A5 and the external thread 13A. Alternatively, when the connector 15A continues to move along the +Z-axis, the connector 15A may disengage from the coaxial cable connector 13. Alternatively, when the connector 15A continues to move along the –Z-axis, the connector 15A may press against coaxial cable connector 13 to fix a relative position of coaxial cable connector 13 and connector 15A, thereby maintaining the electrical connection between coaxial cable connector 13 and coaxial cable 15.

As illustrated in FIG. 4B, a first protrusion length L1 of the first protrusion 120 relative to the inner peripheral surface 110s is less than a second protrusion length L2 of the second protrusion 130 relative to the inner peripheral surface 110s (the inner peripheral surface 110s is illustrated in FIG. 3B). In another embodiment, the first protrusion length L1 may be equal to or greater than the second protrusion length L2. A relationship between the first protrusion length L1 and the second protrusion length L2 may depend on a relative relationship of the peripheral elements, and it is not limited in this embodiment of the invention.

As illustrated in FIGS. 2A, 3B, and 4B, the sleeve body 110 has at least one notch 110t. The notch 110t extends from the first end surface 110e1 of the sleeve body 110 towards the second end surface 110e2. A flexible portion 111 is formed between adjacent notches 110t. Due to the deformability of the flexible portions, during the process of engaging the sleeve body 110 with the fixing element 12, the flexible portions 111 may adaptably deform, and thus it allows the sleeve body 110 to be engaged with the fixing element 12 with less effort.

As illustrated in FIGS. 2A, 2C and 3B, in an embodiment, the fixing element 12 has a plurality of notches 12C, and the notches 12C pass through the fastening body 12A and the flange 12B to form a plurality of flexible portions 12D, wherein each flexible portion 12D includes a portion of the fastening body 12A and a portion of the flange 12B. The flexible portions 12D are separated from each other, and thus it may increase the flexibility of the fixing element 12. The flexible portion 12D has a fixed end 12D1a and a free end 12D1b. The fixed end 12D1a is fixed to the housing 11, while the free end 12D1b is flexible relative to the fixed end 12D1a. Due to the flexible portion 12D being flexible, it may be easily connected to the sleeve body 110.

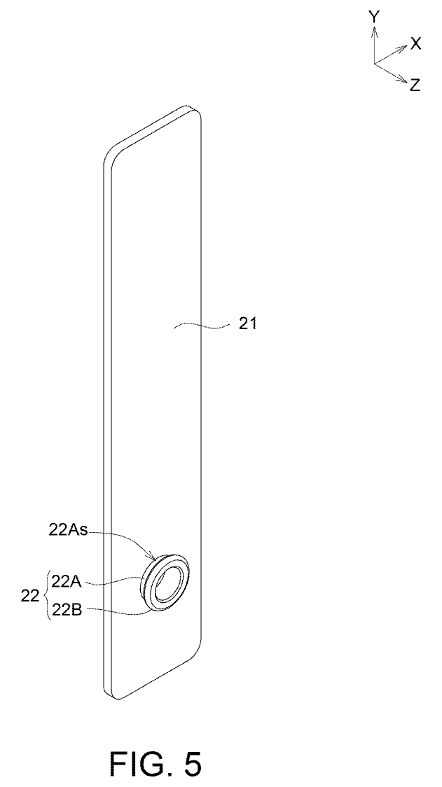

Referring to FIG. 5, FIG. 5 illustrates a schematic diagram of a housing 21 and a fixing element 22 according to another embodiment of the present invention. In an embodiment, the fixing element 12 and the housing 11 of the wiring structure 10A of the aforementioned embodiment may be replaced by the fixing element 22 and the housing 21 of the present embodiment.

As illustrated in FIG. 5, the fixing element 22 is connected to the housing 21. The housing 21 and the fixing element 22 are formed, for example, into an integral structure. In terms of manufacturing method, the housing 21 and the fixing element 22 may be formed, for example, by injection molding. Alternatively, the housing 21 and the fixing element 22 may be manufactured independently and then combined together by means of bonding, snap-fitting, screwing, welding, etc. In terms of materials, the housing 21 and/or the fixing element 22 are made of, for example, plastic or metal.

As illustrated in FIG. 5, the fixing element 22 includes a fastening body 22A and a flange 22B. The fastening body 22A is connected to the housing 21, and the flange 22B is connected to the fastening body 22A and protrudes relative to an outer peripheral surface 22As of the fastening body 22A. Unlike the fixing element 12 in the previous embodiment, the fixing element 22 in the present embodiment is an intact annular body and does not have any notch that would form a flexible portion.

In summary, this disclosure provides an embodiment of an electronic device including a protective sleeve, a housing and a fixing element, wherein the fixing element is attached to the housing. The protective sleeve may be attached to the fixing element and become a part of the electronic device. That is, the protective sleeve may be normally held on the fixing element. By operating the protective sleeve, the connector of the coaxial cable may be rotated without additional tools.

While the invention has been described by way of example and in terms of the preferred embodiment (s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A protective sleeve for a coaxial cable, comprising:
a sleeve body having a central axis and an inner peripheral surface surrounding the central axis; and
a first protrusion connected to the inner peripheral surface and protruding relative to the inner peripheral surface,
wherein the sleeve body has a plurality of notches, the notches extend from a first end surface of the sleeve body toward a second end surface of the sleeve body, and a flexible portion is formed between adjacent two of the plurality of notches.

2. The protective sleeve as claimed in claim 1, further comprising:
a plurality of the first protrusions surrounding the central axis of the sleeve body.

3. The protective sleeve as claimed in claim 1, wherein the first protrusion is connected to the first end surface.

4. The protective sleeve as claimed in claim 1, further comprising:
a plurality of second protrusions connected to the inner peripheral surface of the sleeve body, protruding relative to the inner peripheral surface and surrounding the central axis of the sleeve body.

5. The protective sleeve as claimed in claim 1, further comprising:
a second protrusion connected to the inner peripheral surface of the sleeve body and protruding relative to the inner peripheral surface of the sleeve body;
wherein the second protrusion is spaced apart from the first protrusion and protrudes from the inner peripheral surface.

6. An electronic device, comprising:
a housing having a lateral surface;
a fixing element connected to the housing;
a coaxial cable connector disposed within the housing and protruding relative to the lateral surface; and
a protective sleeve, comprising:
a sleeve body having a central axis and an inner peripheral surface surrounding the central axis; and
a first protrusion connected to and protruding relative to the inner peripheral surface;
wherein the first protrusion of the protective sleeve is connected to the fixing element,
wherein the fixing element comprises:
a fastening body having an outer peripheral surface; and
a flange connected to the fastening body and protruding relative to the outer peripheral surface;
wherein the first protrusion of the protective sleeve overlaps with the flange along an extension direction of the central axis of the sleeve body.

7. The electronic device as claimed in claim 6, wherein the protective sleeve further comprises:
a plurality of the first protrusions surrounding the central axis of the sleeve body.

8. The electronic device as claimed in claim 6, wherein the sleeve body has a first end surface, and the first protrusion is connected to the first end surface.

9. The electronic device as claimed in claim 6, wherein the protective sleeve further comprises:
a plurality of second protrusions connected to the inner peripheral surface of the sleeve body and surrounding the central axis of the sleeve body.
